(19) United States
(12) Patent Application Publication
(10) Pub. No.: US 2003/0118806 A1
(43) Pub. Date: Jun. 26, 2003

(54) Composite component for vehicle bodies

(76) Inventor: Horst Schonebeck, Gelnhausen (DE)

Correspondence Address: CARLSON, GASKEY & OLDS, P.C., 400 WEST MAPLE ROAD, SUITE 350, BIRMINGHAM, MI, 48009, US

(21) Appl. No.: 10/319,429

(22) Filed: Dec. 13, 2002

(30) Foreign Application Priority Data
Dec. 15, 2001 (DE) 101 61 745.3

(51) Int. Cl. B32B 3/26; B32B 5/14; B32B 9/00

(52) U.S. Cl. 428/304.4; 428/309.9; 428/318.4; 442/370

(57) ABSTRACT

A composite component for vehicle bodies, for vehicle roofs in particular, is suggested, which has a firm outer skin and a plastic layer expanded in a foaming form against the interior of the outer skin. According to the invention a reinforcing layer is formed against the interior of the plastic layer which is already held at a defined distance in the foaming form by the outer skin. The result is the creation of a composite component for vehicle bodies which component can be easily mass-produced and whose stability and resistance characteristics can be adjusted in a defined manner during manufacture.

### BACKGROUND OF THE INVENTION

This invention relates to a composite component for vehicle bodies, for vehicle roofs in particular.

In the state of the art there is no lack of suggestions as to how to construct composite components for vehicle bodies. For example, the applicant's class-forming EP 0 995 667 A1 discloses a composite component, for vehicle roofs in particular, which has a moulded outer skin and a plastic layer foamed against the interior of the outer skin, the plastic layer being capable of being provided on its surface with a textile, planar formed body or a decorated plastic film. In order to prepare a sufficiently rigid and yet relatively light composite component, in this state of the art the moulded outer skin is constructed frameless at its edges and set on edge all-round, the plastic layer extending to the setting on edge and provided over the whole of the surface area of the outer skin with an inner reinforcement not rigid in itself in the form of fibre glass length sections twisted in bundles through which the modulus of elasticity of the foamed plastic layer is increased.

Insofar as it needs to be improved, this state of the art is a rather excessive quantity of fibre glass length sections needs to be injected in the plastic layer when it is created with the aid of the so-called LFI procedure (Long Fibre Injection), in order to achieve the desired stability and strength characteristics of the composite component with sufficient reliability. Achieving the stability and strength characteristics of the composite component in a targeted manner in accordance with the respective requirements is also difficult.

The same applies to the vehicle body component of sandwich construction known from EP 1 101 590 A1, the polyurethane foam material used containing glass fibre elements in order to increase the strength of the foam layer thus formed.

DE 196 32 055 C1 is discloses a roof reinforcement for vehicles fitted from the inside to the roof skin of a conventional vehicle roof. With this state of the art a flat, multi-layer semi-finished product made from two outer kraft liners and a central polyurethane, high-resistance foam layer, this semi-finished product being split along the centre and cut to suit the dimensions of the roof skin with some excess. A single kraft liner is also cut to suit the dimensions of the roof skin with some excess, whereupon the element cut to size of the split semi-finished product and the element cut to size of the individual kraft liner is reshaped and glued together with a layer of glue between the side of the hard foam layer and the individual kraft liner to form the final shape in a moulding tool matching the camber and contour of the roof skin. The roof reinforcement thus formed is then glued to the roof skin of the vehicle roof.

Even with this relatively expensive procedure for reinforcing the roof skin of a vehicle roof it is difficult to create the same stability and strength characteristics during the mass production of each vehicle roof which depends on the accuracy of the splitting of the multi-layer semi-finished product and the varying quality of the gluing, so that in practice oversizing of the roof reinforcement is a given in terms of the desired stability and strength characteristics of the vehicle roof.

Finally, reference is made to DE 199 56 930 A1 for the purposes of technological background, which discloses a vehicle outer skin component which as an outer thermo-plastic or decorate film and an inner carrier component made of metal or plastic and conferring the desired stability or rigidity upon the outer skin part, directly abutting the reverse side of the coating or decorative film a plastic foam layer is provided which is at least slightly mouldable, which is fitted to the reverse side of the film in a back-foaming tool, in order to provide, in addition to the high-quality, outer surface protection for a person who collides with the outer skin component as the result of an accident.

The task of the invention is to create a composite component for vehicle bodies which can be manufactured simply as far as possible using mass production and whose stability and strength characteristics can be set in a defined manner during manufacture.

### SUMMARY OF THE INVENTION

According to the invention a composite component for vehicle bodies, vehicle roofs in particular, has a solid outer skin and a plastic layer foamed up to form a foamed part facing the inner side of the outer skin, a reinforcing layer also being foamed on at the inner side of the plastic layer, which is already held at a distance in a defined manner from the outer skin in the foamed form.

This means that the composite component can easily be manufactured in accordance with the respective stability and strength requirements, the stability and strength characteristic quantities a well as the section modulus during flexion or torsion being capable of being set in a targeted manner due to the defined distance between the reinforcing layer and the outer skin without the composite component having to be greatly oversized and/or costly. The inventive arrangement does not require additional profile elements for frames and braces for reinforcement. As a result and due to the interaction of the outer skin with the reinforcement layer thus connected via the plastic layer and at a defined distance from the outer skin, the composite component is endowed with a blister resistance and overall strength which satisfies all requirements as regards the inherent stability of the composite component during all vehicle service conditions. If the composite component according to the invention is used for a vehicle roof module this structure, in addition to cost and weight advantages also has the advantage that the interior of the vehicle can be optimised as regards maximum headroom.

As a matter of principle the reinforcing layer can be kept at a defined distance from the outer skin through measures to the foaming form during the foaming procedure, so that even in the case of the finished composite component shaped by the foamed shape a defined distance can be set and maintained between the reinforcing layer and the outer skin due to the plastic layer inserted between. Less costly and therefore preferred, however, is if the reinforcing layer is kept at a defined distance from the outer skin by means of a spacer inserted between the reinforcing layer and the outer skin, which in the finished composite component represents an integral part of same. In one example, the spacer is preferably penetrated by the plastic of the plastic layer, which promotes high structural strength and dimensional stability of the composite component.

In one example embodiment the spacer is at least partially ductile at least prior to foaming up the plastic layer by applying a pre-determined force. In this way the spacer can be easily compressed as regards the desired distance between the outer skin and reinforcing layer and also adapted to the desired shape of the composite component without the need for costly shaping of the spacer.

As a matter of principle any material can be used for the spacer which can combine low weight with a certain degree of dimensional stability or inherent rigidity which is sufficient to maintain the pre-determined distance between the outer skin and reinforcing layer during the foaming process. However it is preferable, particularly on cost grounds, for the spacer to be made of a plastic foam mat whose open cell structure forms an irregular space lattice that can adapt to the shape of the outer skin into its edge areas and can be penetrated and enclosed by the foaming plastic in the enclosed foaming form. In one example the plastic foam of the spacer is a polyurethane polyester foamed under nitrogen impacting.

Any woven fabric, knitted fabric, non-woven fabric, lattice, mat and similar planar formed body made of fibre glass or carbon fibre, plastic fibre such as polyester (e.g. Diolen®), or aramide (e.g. Kevlar®) fibres, cellulose fibres or natural fibres such as sisal or flax fibres, even in combination can be considered as the reinforcing layer as a matter of principle, provided that they are suitable for forming a reinforcement in the sense of increasing the mechanical strength characteristics due to their planar structure and/or the characteristics of the materials used respectively. However, it is preferable for the reinforcing layer to be made of a fibre glass mat, which, according to investigations made by the applicant represent a good compromise in terms of cost, weight as well as simple processing capability.

In one example the reinforcing layer is penetrated by the plastic from the plastic layer, so that the best possible connection between the plastic layer and the reinforcing layer is provided.

In one example embodiment the inner side of the outer skin has a further reinforcing layer preferably made of a glass fibre mat penetrated by the plastic of the plastic layer. Such a further reinforcing layer abutting directly the outer skin, which can be formed as the first reinforcing layer (i.e., as described above) has the advantage in that the outer skin which is normally made of a higher-quality material, does not need to be made excessively thick in a cost-effective manner in order to guarantee the necessary strength characteristics of the composite component. Even if the composite component in addition to an initial fibre glass mat as inner reinforcing layer also has an additional fibre glass mat as a further, outer reinforcing layer, then for the same outer skin thickness overall fewer glass fibres are required to achieve comparable strength characteristics of the composite component than in the class-forming state of the art, in which glass fibres are injected into the plastic layer as reinforcement using the LFI process.

In one example the plastic layer foamed against the inner side of the outer skin is made advantageously from a polyurethane foam formed from a polyol and an isocynate in the mix ratio of 100 to 150 to 100 to 180.

In an advantageous further development of the composite component according to the invention an inner lining is attached to the inner side of the reinforcing layer, so that the composite component can be used for extensive vehicle body series parts, which form both an outer as well as an inner surface area of the vehicle body, the surface area facing the passenger compartment.

In one embodiment at least one cavity is formed as a functional section of the composite component between the reinforcing layer and the inner lining. Such functional sections can serve, in accordance with the respective requirements, and with no further lining as, for example ventilation channels but also as holders for further components such as cables, housings, pipes, etc. with no additional lining. Also with the appropriate selection of geometry and size as well as distribution pattern of the cavities an advantageous effect can be had on the sound absorption or insulation characteristics as well as the heat transition characteristics of the composite component.

In one example the inner lining has two reinforcing layers kept at a distance by a spacer, the spacer and the reinforcing layers being penetrated by a foamable plastic. Such a formed inner lining can be manufactured easily and advantageously.

If the inner lining spacer is at least partially ductile at least prior to the application of the plastic under the application of pre-determined force, it is not only possible in a simple manner not only to form, in accordance with the insulation and/or accident safety requirements, inner lining areas of various wall thickness, said cavities can also easily be formed on the side of the inner lining facing the outer skin and/or on the side of the inner lining facing the passenger compartment in the form of recesses in the form of for example three-dimensional decorative images or motifs. To do this, only the mould halves of the foaming tool need to be provided with an appropriate (negative) geometry.

In another embodiment the spacers are made of a plastic foam mat whose open cell structure forms an irregular space lattice. In a particular example the plastic foam of the spacer for the inner lining is also a foamed polyurethane polyester foamed under nitrogen impacting. Finally, the same applies accordingly to the reinforcing layers of the inner lining. In particular it is preferable for the reinforcing layers of the inner lining also to be made respectively of a fibre glass mat.

The plastic introduced into the spacer and the reinforcing layers of the inner lining in one example is preferably a polyurethane foam, formed from a polyol and an isocyanate in the mixing ratio 100 to 50 to 100 to 80. As a result of the mixing ratio which differs from the mixing ratio for the plastic layer at the outer skin the plastic layer of the inner lining is softer than the plastic layer at the outer skin, which has a proportionately high hardness and rigidity.

The plastic of the inner lining can be mixed with an additive containing an aroma concentrate respectively a scent additive. Such an additive can be oil or alcohol, for example, in which the aroma concentrate is dissolved, like a perfume oil or an alcoholic solution of appropriate aromatics. In this way any unpleasant characteristic odour of the inner lining can be masked advantageously, such an odour frequently being perceived as disturbing especially in the case of new vehicles, and/or a car sale may be stimulated by a suggestive, illusory odour.

In another example the inner lining having has optics and haptics layer, which for their part are formed as a sandwich construction from a soft plastic foam or felt layer and a decorative layer. With such an optics and haptics layer the inner lining can easily be adapted to the interior fittings of the vehicle in accordance with the respective requirements in terms of outer appearance (decorative layer: color, decorative material; plastic foam or felt layer: feel, so-called “soft touch”). The decorative layer of the optics and haptics layer can be made of a textile planar formed body, leather, imitation leather or suede or a decorative plastic film, depending on the respective design requirements. Furthermore, the plastic foam or felt layer of the optics and haptics layer promotes good sound absorption of the composite component.

Another embodiment provides for an essentially fluid-tight barrier layer inserted between the inner reinforcing layer and the optics and haptics layer of the inner lining. Such a barrier layer serves advantageously to prevent the foaming plastic bleeding through the pores of the optics and haptics layer of the inner lining into the lining's visual range.

The barrier layer may also be made of a polyurethane foam as a matter of principle. It is preferable, however, for the barrier layer to be made of an open-cell polyethylene foam, which has a better barrier effect compared with the polyurethane foam, as tests by the applicant have shown.

The inner lining of one example is preferably formed to be light- and/or air-permeable, so that when the composite component is used in the roof area by arranging suitable lamps in cavities, which can be provided as functional sections between the reinforcing layer and the inner lining, the passenger compartment can be illuminated. If the inner lining is air-permeable and there is an appropriate arrangement of cavities formed as ventilation channels between the reinforcing layer and the inner lining, which can be supplied by an air-conditioning device or a vehicle ventilation system, it is possible to provide pressure cooling of the passenger compartment advantageously (“air shower”), which until now has created problems particularly in the rear region of the passenger compartment in the direction of travel.

According to the invention constructed composite components are fundamentally suitable for all surface areas of vehicle bodies, including roofs, doors and flaps/covers, for which good heat and/or sound insulation characteristics are required in addition to sufficient buckling strength and resistance as well as flexural and torsional strength together with low weight. When a vehicle roof is mentioned in the following this is a preferred place of application of the invention, but without limiting the meaning.

### BRIEF DESCRIPTION OF THE DRAWINGS

The invention is described in more detail in the following on the based of preferred example embodiments with reference to the enclosed, partially schematic drawings of which:

FIG. 1 is a schematic, perspective view of a vehicle component already fitted to a motor vehicle body as an example of a composite component according to the invention.

FIG. 2 is the broken section through a side region of the vehicle roof module along the line II-II in FIG. 1.

FIG. 3 is a schematic sectional view on an enlarged scale of detail III in FIG. 2, which shows the details of the sandwich structure of the vehicle roof module.

FIG. 4 is a variant corresponding to the method of representation of FIG. 3 of the sandwich structure of the vehicle roof module, cavities being formed as functional sections of the composite component between the inner reinforcing layer for the outer skin and the outer reinforcing layer of the inner lining.

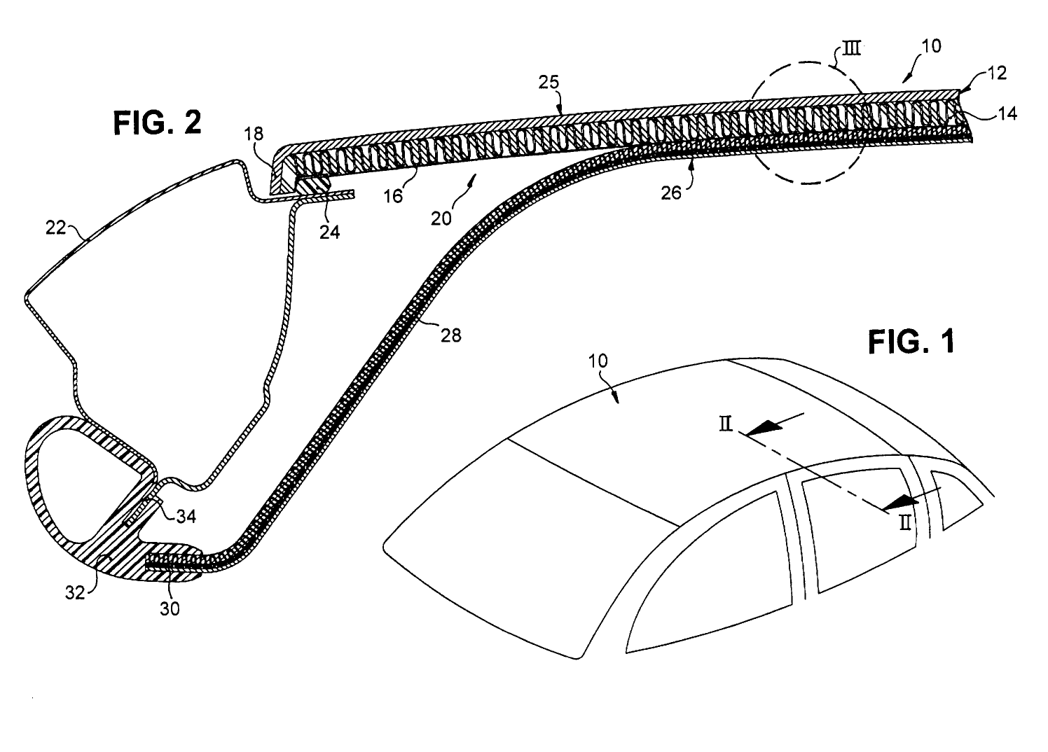

### DETAILED DESCRIPTION OF THE PREFERRED EMBODIMENTS

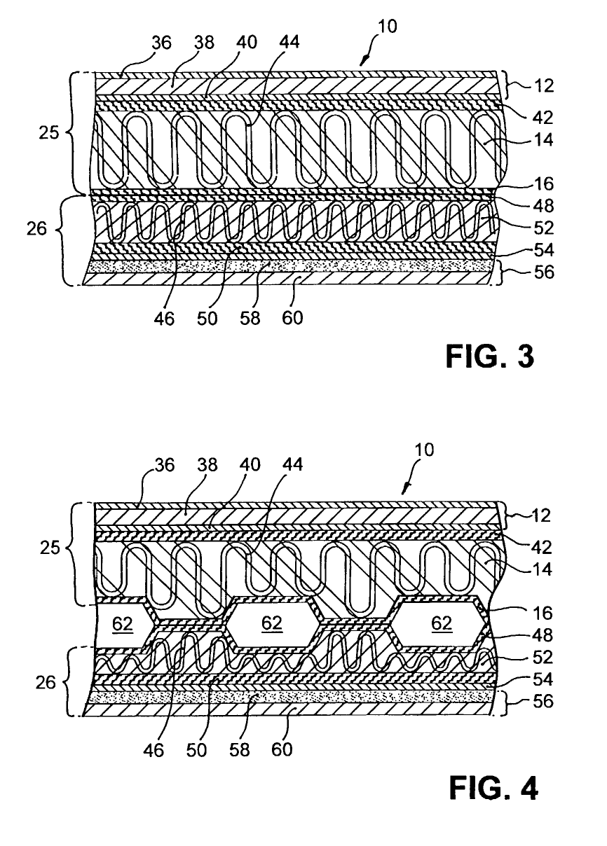

The figures show for a composite component 10 for example a vehicle roof module which has a firm respectively rigid outer skin 12 and a plastic layer 14 foamed against the inner side of the outer skin 12 in a foamed shape (not shown). What is significant—as will be described in more detail in the following with reference to FIGS. 3 and 4—is that a reinforcing layer 16 is foamed on the inner side of the plastic layer 14 (i.e., in FIGS. 2 to 4 below the plastic layer 14) as well, and which in the foamed body is maintained at a distance from the outer skin 12, in order to provide the composite component 10 with a pre-determined stability or rigidity.

As FIG. 2 shows the composite component 10 is placed with its outer edges, which terminate with the outer skin 12 set on edge 18 on a body frame 22 surrounding a roof opening 20 and firmly secured to this using adhesive beads 24 for example. The outer skin 12, the plastic layer 14 and the reinforcing layer 16 form here a solid outer or roof shell 25 of the composite component 10 lying on top of the body frame 22.

To the inner side of the reinforcing layer 16, i.e. on the side of the outer shell 25 facing the passenger compartments, an inner lining 26 is secured forming an inside roof lining and which is described in more detail with reference to FIGS. 3 and 4. In the example embodiment shown the inner lining 26 is secured to the reinforcing layer 16 using adhesive. The inner lining 26 of the composite component 10 can, however, also be secured detachably using Velcro strips or—as described in DE 199 47 238 A1 or the older German patent application 101 16 593.5 made by the applicant—mechanically to the outer shell 25.

The inner lining 26 is not secured to the reinforcing layer 16 in the outer edge region of the outer shell 25. Here the inner lining 26 of the outer shell 25 has drooping, flexible edge regions 28, which are sized so that they extend over the outer shell 25 and can line the side of the body frame 22 facing the passenger compartment. In order to secure the edge region 28 of the inner lining 26 in its position lining the body frame 22 the end 30 of the edge region 28 is inserted into a weatherstrip 32 made of plastic, which is in turn placed on a corresponding flange 34 of the body frame 22. In the example embodiment shown the weatherstrip 32 formed as a hollow-chamber profile section forms one part of the door seal for the vehicle.

In the following and with reference to FIGS. 3 and 4 the sandwich structure of the composite component 10 starting with that of the outer side facing the environment and proceeding to that of the inner side facing the passenger compartment (i.e., as described from top to bottom in FIGS. 3 and 4.

In the example embodiment shown the outer skin 12 of the outer shell 25 consists of three layers, namely an outer paint layer 36, a middle carrier layer 38 and an inner primer layer 40. The paint layer 36 can itself also have—not shown here for the sake of clarity—a three-layer structure, with a primary layer applied to the carrier layer 38 on epoxy resin base about 5 to 7 μm thick as bonding agent, a coloring top coat of paint on polyester base about 18 to 23 μm thick applied to the primer layer and a clear varnish layer of polyvinylide fluoride (PVDF) about 22 μm thick covering the top coat of paint. With such a structure of the paint layer 36 and use of a thin aluminium sheet for the carrier layer 38, an AlMg sheet, say, 0.4 Si 1.2, the aluminium sheet can be fully painted in the desired color prior to hydraulic deep-drawing deformation. Tests by the applicant have shown that a paint layer 36 with such a structure and covered with a protective film can withstand multi-stage deep-draw deformation with deep-draw speeds of up to 60 mm/s intact, i.e. with no cracks or other damage, as was shown after the protective film was removed. However, paint systems on acrylic resin base or polyurethane basis are conceivable for paint layer 36.

In addition to the aluminium alloy mentioned other metal materials are also suitable as a matter of principle, for example steel, for the carrier layer 38. If the carrier layer 38 is made of a metal material in the example embodiment shown, the primer layer 40 is applied to the inner side of the carrier layer 38, which primer layer can be formed from epoxy resin and serves as a bonding agent between the outer skin 12 and the plastic layer 14 due to its affinity with the plastic of the plastic layer 14.

Alternatively, the outer skin can also be formed from a thermo-plastic plastic film, preferably from a two-layer co-extrusion film made, for example from polymethyl methacrylate (PMMA) for the outer layer as well as a mixture of polycarbonate (PC) and acryl nitrol styrol acrylic acid ester copolymerisate (ASA) for the inner layer, the thickness of the outer layer making up about 15% of the overall thickness for preference. The use of a plastic film offers the advantage of the plastic being capable of being penetrated with dye of the desired color as a block, so that painting is dispensed with. Also, and in accordance with the respective requirements, the plastic film can also be provided with a shiny finish using a highly-polished deep-drawing mould for the manufacture of the shell-like outer skin or a grained finish produced by calendering beforehand. The latter measure for the co-extruded plastic film enables the microgeometry of the outer surface of the outer skin to be shaped in the sense of a so-called “aimed structure” such that this develops dirt-repelling characteristics—so-called “lotus flower” effect—or noise- respectively air-resistance reducing characteristics—so-called “sharkskin” effect. If a plastic film is used as the outer skin the inner side of the outer skin is singed to activate it prior to application of the foaming plastic of the plastic layer, an excellent bonding of the outer skin with the foamed plastic layer being achieved with the need for a primer layer.

The thickness range of the outer skin 12 is between 0.6 mm and about 1.3 mm, the lower value applying to an outer skin 12 whose carrier layer 38 is made from aluminium or steel, whereas the larger value applies to an outer skin made from a plastic film.

In connection with the outer skin 12 reference is made to the fact that tracks (not shown here) can be formed for, for example, roof antennae, loudspeaker systems, GPS, light systems prior to foaming the plastic layer 14 using a suitable printing method such as screen printing. Compared with anticipated solutions, with which, for example, the antennae leads can be secured to the roof outer skin from the inside by gluing or mechanically, such a formation of tracks by printing has the particular advantage in that the tracks can be made very flat and thus only increases the thickness of the outer skin 25 only very slightly or only partially.

In the example embodiment shown a further, outer reinforcing layer 42 is connected to the outer skin 12 on its inner side. This reinforcing layer may be made of materials already described in the introduction to the description as a matter of principle, but preferably of a fibre glass mat and penetrated by the plastic of the plastic layer 14. The reinforcing layer 42 has in its preferred embodiment a plurality of glass fibre bundles which are compressed with random orientation to form a glass fibre mat approximately 0.5 mm thick prior to the formation of the composite component 10. The same applies to the inner reinforcing layer 16 which is also preferably made of a glass fibre mat, penetrated by the plastic of the plastic layer 14 and having a thickness of at least 0.5 mm.

Between the reinforcing layers 16 and 42 a spacer 44 penetrated by the plastic of the plastic layer 14 is inserted, this spacer serving to maintain the reinforcing layer 16 at a defined distance from the outer skin 12, if the plastic layer 14 has the foaming form not shown here. To do this, the spacer 44 must be at least partially ductile when a pre-determined force is applied at least prior to the foaming of the plastic layer 14. In other words, the spacer 44 has a certain spring effect, on the basis of which when the composite component 10 is formed the reinforcing layer 16 in the enclosed foaming form opposite the outer skin 12 abutting one half of the foaming form across the whole of its surface area is pressed sprung with the whole of its surface area against the other half of the foaming form, whilst the non-reinforced plastic of the plastic layer 14 foams and supports this spring effect.

The spacer 44 is only represented schematically by a double wavy line in the figures. However, in a preferred embodiment, the spacer 44 actually comprises a plastic foam mat whose very open cell structure forms an irregular space lattice which is similar in appearance to osteoporous bone tissue. The foam plastic of the spacer 44 is preferably polyurethane polyester foamed under the impact of nitrogen, which, after foaming, has a low apparent density of about 20 kg/m³, a wear hardness of about 20 kPa, a cell number of approximately 13 cells per cm, a tensile strength of about 230 kPa and a ductile yield of about 70%. Such a spacer might also be made of a polyamide which is less preferred, however, on recycling grounds in particular. The use of other known reticulated foam plastics is also conceivable, particularly those known from filter applications.

The plastic layer 14 foamed against the inner side of the outer skin 12 itself consists for preference of an open-cell polyurethane foam, formed from a polyol and an isocyanate in a mixing ratio between approx. 100 polyol parts/150 isocyanate parts and approximately 100 polyol parts/180 isocyanate parts. This foam plastic is distinguished by its low weight with proportionately high rigidity and also offers good heat stability and fragmentation behaviour. The thickness of the plastic layer 14 between the reinforcing layers 16 and 42 may vary across the length respectively the width of the composite component 10, but is generally between 4 and 12 mm.

As already described with reference to FIG. 2, the inner lining 26 is suitably secured to the inner side of the reinforcing layer 16 of the outer skin 25. The inner lining 26 comprises two reinforcing layers 48, 50 maintained at a distance using a spacer 46, the spacer 46 and the reinforcing layers 48, 50 being penetrated by a foamable plastic 52. As regards the material, structure and function of the spacer 46 reference is made at this point to the above description of the spacer 44 in the outer shell 25. The spacer 46 in particular of the inner lining 26 is at least partially ductile prior to charging the plastic 52 under application of a pre-determined force and preferably comprises a foam plastic mat whose open cell structure forms an irregular space lattice, the foam plastic of the spacer 46 preferably being a polyurethane-polyester foamed under the impact of nitrogen.

Reference can also be made to the above description of the reinforcing layers 16 and 42 of the outer shell 25 as regards the reinforcing layers 48 and 50 of the inner lining 26 as well. It is particularly preferable for the reinforcing layers 48 and 50 to comprise respectively a glass fibre mat approximately 0.5 mm thick.

The plastic 52 introduced in the spacer 44 and the reinforcing layers 48, 50 of the inner lining 26 is preferably polyurethane foam, formed from a polyol and an isocyanate in the mixing ratio of approximately 100 polyol parts/50 isocyanate parts to approximately 100 polyol parts/80 isocyanate parts. The plastic foam 52 which is softer than the plastic foam 14 of the outer shell 25 is distinguished in particular for its good airborne noise absorption characteristics. As already discussed at the start, the plastic 52 can be mixed with an additive which contains an aroma concentrate, in order to confer a particular odour on the inner lining 26 respectively to mask an intrinsic odour of the outer shell 25 and/or the inner lining 26, which may be the result of chemical solvents perhaps in the plastics used for the outer shell 25 respectively the inner lining 26. This additive (perfume oil respectively aromates in alcohol solution) is mixed advantageously in with one of the polyurethane foam constituents, i.e. the polyol or the isocyanate, before these constituents mingle as a result of mixing.

The thickness of the plastic layer 52 between the reinforcing layers 48 and 50 is generally approximately 3 to 6 mm. With appropriate recesses respectively cavities in the foaming form not shown here for the inner lining 26 thicker regions may also be formed locally in order to form shock-absorbing lining sections in the region of the body frame 22 which satisfies MVSS 201 (Head Impact Protection).

An essentially fluid-tight and yet air-permeable barrier layer 54 is connected to the inner reinforcing layer 50 of the inner lining 26 and which preferably comprises an open-celled polyethylene foam and has a thickness of approximately 1 mm. The barrier layer 54 serves to reduce in the foaming form for the inner lining 26 bleeding through of the foaming plastic of the plastic layer 52 into an optics and haptics layer 56 adjoining the barrier layer 54 on the inner side of the inner lining 26 respectively to prevent such bleeding, the optics and haptics layer 56 being glued to the barrier layer 54 using a thermoplastic adhesive.

The inner optics and haptics layer 56 of the inner lining 26 is, finally, formed sandwich-like from a soft foam plastic or felt layer 58 and a decorative layer 60. Here, the foam plastic layer 58 is preferably made of an open-celled block foam with an apparent density of approximately 20 kg/m³ and a thickness of approximately 1 to 3.5 mm, which also has good sound insulation characteristics. The decorative layer 60 connected with the foam plastic layer 58 using a thermoplastic adhesive and which has a thickness of approximately 0.5 to 1.5 mm and which may be needled under certain circumstances in order to guarantee air permeability, can ultimately be made of a textile planar formed body, leather, imitation leather or suede (Alcantara®) or a decorative plastic film. It is obvious that textile planar formed bodies and plastic films in particular also permit multi-colored formation of the decorative layer 60.

FIG. 4. shows a variant of the sandwich structure of the composite component 10 shown in FIG. 3, a variant which differs essentially from the latter in that several cavities 62 extending channel-like in the longitudinal direction of the composite component 10 are formed between the inner reinforcing layer 16 of the outer shell 25 and the outer reinforcing layer 48 of the inner lining 26 as functional sections of the composite component 10. The cavities 62 may serve, for example, as ventilation channels or to accept further components such as cables, hose, pipes, lamps etc. In the case of the variant of the sandwich structure shown in FIG. 4 in particular the inner lining 26 may be advantageously light- and air-permeable by the selection of appropriate material and sizing, so that the passenger compartment can be illuminated from the top by the lamps (not shown) accepted in the cavities 62 respectively the passenger compartment can be ventilated through the inner lining 26 via the cavities 62. Such cavities 62 can be easily formed in that at least one of the foaming forms for the outer shell 25 and the inner lining 26 has an appropriately structured surface on one form half.

It should also be mentioned in this connection that in an appropriate manner three-dimensional motifs or images can also be formed on the inner side of the inner lining 26, i.e. by providing a suitably structured surface on the corresponding form half of the foaming form for the inner lining 26, which surface is clearly formed during the foaming process through the elastic optics and haptics layer 56, the barrier layer 54 and the (initially) flexible reinforcing layer 50 in the foaming plastic layer 52 of the inner lining 26.

Even though not shown in the figures, further functional elements may ultimately be foamed in particular in the plastic layer 14 of the outer shell 25 in accordance with the respective requirements, such as profiles for cable conduits, water outlets, guide profiles for an optional sliding cover to seal an opening in the outer skin, and/or fixing respectively connecting elements for this and/or for handles, sun visors, etc.

The composite component 10 with the sandwich structure described above is manufactured as follows. Advantageously, solvents need not be used.

Initially to form the outer shell 25 the outer skin 12 pre-formed in known fashion to accommodate the desired roof contour is placed with a positive fit in the lower form half of the foaming form for the outer shell 25. The reinforcing layer 42, the spacer 44 and the reinforcing layer 16 are then placed in this sequence on the inner side of the outer skin 12. The liquid plastic mass for the plastic layer 14 mixed in a mixer is then applied to the reinforcing layer 16 starting approximately in its centre and then following an approximate spiral path, the plastic mass, which has fluidity similar to water in the liquid state, immediately saturates the reinforcing layer 16, the spacer 44 and the reinforcing layer 42. The upper form half of the foaming form is then placed on the lower form half, in other words the foaming form is closed with the spacer 44 only compressed locally under certain circumstances in accordance with the geometry of the upper form half, so that the reinforcing layer 16—as already mentioned above—is pressed onto the upper form half by the spacer 44 or, in other words, maintained at a pre-determined distance from the outer skin 12. The inflating plastic foam fills the foaming form sealed appropriately between the form halves and penetrates as far as the edge regions of the outer skin 12 the edge regions to be cut later under certain circumstances. After expiry of a certain reaction time the foaming form is opened and the one-piece outer shell 25 taken out of the foaming form.

The inner lining 26 is manufactured independently as regards time from the formation of the outer shell 25. To do this, the reinforcing layer 48, the spacer 46 and the reinforcing layer 50 are placed in this sequence on the surface, which may be structured under certain circumstances, of the lower form half of the foaming form for the inner lining 26. The sandwich layer comprising barrier layer 54 and optics and haptics layer 56 and already glued is also secured in clamped fashion temporarily to the upper form half of the foaming form using a stentering frame set into a groove or recess of the upper form half of the foaming form, so that the barrier layer 54 is on the side of the upper form half facing the lower form half. The plastic mass which is liquid similar to water and mixed in a mixer for the plastic layer 52 is applied to the reinforcing layer 50 starting in its middle and following a spiral-like path, the plastic mass immediately saturating the reinforcing layer 50, the spacer 46 and the reinforcing layer 48. The upper form half of the foaming form is then placed on the lower form half respectively the foaming form is sealed tight. With its elastic characteristics in conjunction with the displacement forces of the inflating plastic form the spacer 46 ensures that the surfaces of the foam halves which may be structured form in the plastic layer 52 through the reinforcing layer 48 respectively the sandwich layer comprising the optics and haptics layer 56 as well as barrier layer 54. After a certain reaction time has expired the foaming form is opened and the resulting single-piece inner lining 26 removed from the foaming form.

Finally, adhesion surface areas are prepared on the inner side of the reinforcing layer 16 of the outer shell 25 and on the outer side of the reinforcing layer 48 of the inner lining 26 and the inner lining 26 glued to the outer shell 25 to form a single-piece sandwich.

A composite component for vehicle bodies, and in particular for vehicle roofs, has been described, which has a firm outer skin and a plastic layer foamed onto the inner side of the outer skin in a foaming form. According to the invention a reinforcing layer is also foamed onto the inner side of the plastic layer at the same time and which is already maintained at a defined distance from the outer skin in the foaming form. The result is a composite component for vehicle bodies which is easily mass-produced and whose stability and strength characteristics can be specifically adjusted during manufacture.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A composite component for a vehicle body, comprising:
a firm outer skin;
a plastic layer foamed onto an inner side of the outer skin; and
a reinforcing layer foamed onto a side of the plastic layer opposite from the outer skin, the reinforcing layer at a selected distance from the outer skin.

2. The composite component of claim 1, including a spacer between the reinforcing layer and the outer skin, the spacer maintaining the reinforcing layer at the selected distance from the outer skin.

3. The composite component of claim 2, wherein the spacer is at least partially penetrated by the plastic of the plastic layer,

4. The composite component of claim 2, wherein the spacer comprises a foam plastic having an open cell structure.

5. The composite component of claim 4, wherein the foam plastic mat open cell structure comprises an irregular space lattice.

6. The composite component of claim 4, wherein the spacer comprises a polyurethane polyester.

7. The composite component of claim 1, wherein the reinforcing layer comprises a glass fibre mat.

8. The composite component of claim 1, wherein the reinforcing layer is at least partially penetrated by the plastic of the plastic layer.

9. The composite component of claim 1, including a second reinforcing layer that comprises a glass fibre mat between the outer skin and the plastic layer and wherein the second reinforcing layer is at least partially penetrated by the plastic of the plastic layer.

10. The composite component of claim 1, wherein the plastic layer comprises a polyurethane foam containing a polyol and an isocyanate in a mixing ratio from about 100 to 150 to about 100 to 180.

11. The composite component of claim 1, including a lining secured to the reinforcing layer on an opposite side of the reinforcing layer from the plastic layer with at least one cavity formed between the reinforcing layer and the lining.

12. The composite component of claim 1, including a lining secured to a side of the reinforcing layer that is opposite from the plastic layer and wherein the inner lining comprises two reinforcing layers, a spacer and a foamable plastic at least partially penetrating the spacer, the spacer and the plastic being between the two reinforcing layers.

13. The composite component of claim 12, wherein the spacer of the lining comprises a foam plastic mat having an open cell structure.

14. The composite component of claim 12, wherein the spacer of the lining comprises a polyurethane polyester.

15. The composite component of claim 12, wherein the lining reinforcing layers comprise glass fibre mats, respectively.

16. The composite component of claim 12, wherein the lining includes an optics layer on a side of the lining adapted to face toward an interior of the vehicle.

17. The composite component of claim 16, wherein the optics layer of the lining comprises one of a soft foam plastic or a felt layer and a decorative layer.

18. The composite component of claim 16, including a fluid-type barrier layer between the reinforcing layer and the optics layer of the lining.

19. The composite component of claims 18, wherein the barrier layer comprises an open-cell polyethylene foam.

20. The composite component of claim 12, wherein the lining is permeable by at least one of light or air.

21. A method of making a composite component for a panel of a vehicle body, comprising the steps of:
providing an outer skin layer;
positioning a reinforcing layer a selected distance from the outer skin layer; and
foaming a plastic layer between the outer skin layer and the reinforcing layer such that the resulting component has the reinforcing layer at the selected distance from the outer skin layer established in the previous step.

22. The method of claim 21, including positioning a spacer between the reinforcing layer and the outer skin layer.

23. The method of claim 22, including at least partially penetrating the spacer material with the plastic of the plastic layer.
